(19) United States
(12) Patent Application Publication
(10) Pub. No.: US 2010/0249751 A1
(43) Pub. Date: Sep. 30, 2010

(54) Device for administering a dose of an analgesic liquid to an infant

(76) Inventors: Raj Agarwal, Chappaqua, NY (US); Neil Agarwal, Chappaqua, NY (US); Bajrang Agarwal, Chappaqua, NY (US)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/456,468

(22) Filed: Jun. 17, 2009

Related U.S. Application Data
(60) Provisional application No. 61/211,289, filed on Mar. 26, 2009.

(51) Int. Cl. A61J 7/00; A61J 17/00

(52) U.S. Cl. 604/514; 604/77

(57) ABSTRACT

A disposable article of manufacture, adapted for use by an infant to provide an analgesic effect, comprises:
(a) a dispensing device having a container portion for holding an analgesic liquid and a contiguous nipple-shaped portion designed to be sucked by an infant, for pacifying the infant while at the same time dispensing and administering the analgesic liquid to the infant through at least one opening in the nipple-shaped portion; and
(b) a dose of the analgesic liquid, in sterile form, disposed in the container portion and/or the nipple-shaped portion of the dispensing device, the dose having a having a volume in the range of 1 to 10 ml and the analgesic liquid consisting essentially of a water solution of sucrose and having a sucrose concentration in the range of 20 to 60% w/v and
(c) a removable article for sealing the opening in the nipple-shaped portion and the dose of analgesic liquid, thereby to prevent entry of bacteria into the analgesic liquid and prevent discharge of the analgesic liquid when the dispensing device is not in use.

### CROSS-REFERENCE TO RELATED APPLICATION

This application claims priority from the U.S. Provisional application No. 61/211,289 filed Mar. 26, 2009 and entitled “DISPOSABLE SUCROSE FILLED PACIFIER”.

### BACKGROUND OF THE INVENTION

The present invention relates to an article of manufacture—in particular, a pacifier-like device—designed and adapted for use by an infant to provide an analgesic effect against physical pain.

In the case of children less than two years of age, numerous misconceptions and false myths about pain and its control have been accepted by lay people and medical practitioners alike. This has led to an unfortunate neglect of infants and children due to failure to recognize and assess their pain in the first instance, resulting in an underestimation of the infant's distress and in inadequate pain management thereafter. Procedures like circumcision, blood tests by means of heel pricks, venipunctures or arterial stabs, intravenous catheter insertion, lumbar puncture, suturing and suture removal, dressing change, urinary catheter insertion, intramuscular or subcutaneous injections, eye examinations, adhesive tape removal and nasogastric administration are all being carried out without any heed to agony of the infant patient.

Not only is the patient affected but a pediatrician with a crying, squirming infant or child has difficulty in administering care. The medical professional would be much better able to care for an infant patient, and the infant would be better able to tolerate the treatment, if attention were given to pain relief so that the infant remained calm and co-operative.

For a young infant in particular, the use of anesthesia to block sensation, usually through loss of consciousness, is recommended only in instances of major surgery, for example to repair a heart valve or to correct a physical birth defect of some kind. Conventional pain medicine, especially morphine-based compositions and other narcotic substances, have significant side effects.

New research shows that newborn infants who are exposed to a series of painful and stressful treatments display a variety of long-term effects as older children, including an altered response to pain and an exaggerated physiological response to stress. It remains unclear whether young infants can remember painful experiences as actual events, but there is evidence that memory for pain may be recorded at the biological level.

Studies have shown that small amounts of a sweet solution, such as a water solution of sucrose, placed in the infant's mouth temporarily reduce the infant's pain. The analgesic effects of such a liquid usually last 5 to 8 minutes, making it an ideal strategy for management of short term pain. The mechanism appears to be an orally mediated increase in endogenous opioid. The higher the dose, greater is the reduction in pain. Repeated doses of sucrose are more effective than is a single dose. Indeed, it has been found that the repeated administration of sucrose is even more effective in reducing pain than is the feeding of milk and its components. See

Tests have determined that the analgesic effect is absent if sucrose is given directly into the stomach via a nasogastric tube. Therefore, oral administration is essential.

Oral sucrose is most effective as a mild analgesic agent for infants in the first month of life. It has also been shown to have analgesic and calming effects up to 18 months of life.

Sucrose may also be indicated for a crying and/or irritable infant, such as a colicky baby, who has not responded to other appropriate interventions such as feeding, cuddling, non-nutritive sucking and wrapping.

In addition, studies have demonstrated that the administration of sucrose combined with the use of a pacifier has a synergistic effect on pain reduction, as the pacifier promotes non-nutritional sucking which contributes to calming. There is a also a significant synergistic effect when sucrose is combined with holding the baby throughout the procedure suggesting that a ‘care giving’ context is beneficial to pain reduction.

Sucrose as a pain reducer and soother has been introduced in the practice of pediatric medical within last few years. Presently, it is primarily being used in the neonatal ICU. Sucrose is introduced into an infant's mouth with help of a syringe or by means of a pacifier dipped in a cup containing a sucrose solution.

The WIPO Patent Publication No. WO/2003/051271 discloses a pacifier-like unit for delivering a single dosage of a liquid medicine to an infant. This dispensing unit comprises a flexible container for the liquid medication having a nipple-shaped portion with an orifice for allowing sucking by a newborn baby. Provision is made to block or seal the nipple orifice until such time as the unit is used.

This dispensing unit may be suitable for delivering any type of liquid medication; however, the disclosure does not teach or suggest the delivery of a liquid having an analgesic effect.

Currently there are no commercially available pre-filled pacifiers with sucrose solution or, as a matter of fact, with any sort of liquid. The reason may be that the liquid must be packaged carefully to remain sterile and avoid bacterial contamination.

### SUMMARY OF THE INVENTION

It is a principal object of the present invention to provide an article of manufacture which is adapted for use by an infant to deliver an analgesic effect against physical pain.

It is a further object of the present invention to provide an article of the type described above which is safe and free from side effects when used by an infant.

It is a further object of the present invention to provide an article of the type described above which is easy to store, easy to use and easy to dispose of after use.

It is a further object of the present invention to provide an article of the type described above which is inexpensive to manufacture.

These objects, as well as other objects which will become apparent from the discussion, are achieved, in accordance with the present invention, by providing a disposable article of manufacture which comprises:

(a) a dispensing device having a container portion for holding an analgesic liquid and a contiguous nipple-shaped portion designed to be sucked by an infant, for pacifying the infant while at the same time dispensing and administering the analgesic liquid to the infant through at least one opening in the nipple-shaped portion;

(b) a dose of the analgesic liquid, in sterile form, disposed in the container portion and/or the nipple-shaped portion of the dispensing device, the dose having a having a volume in the range of 1 to 10 ml and the analgesic liquid consisting essentially of a water solution of sucrose and having a sucrose concentration in the range of 20 to 60% w/v; and

(c) a removable article for sealing the opening in the nipple-shaped portion and the dose of analgesic liquid, thereby to prevent entry of bacteria into the analgesic liquid and prevent discharge of the analgesic liquid when the dispensing device is not in use.

According to the present invention, the unit is designed for one-time use only and, after usage, it may be, and should be, discarded. The dose of analgesic liquid, which may or may not include a preservative, such as methylparaben sorbate and potassium sorbate, is provided and retained in the dispensing device in sterile form, so that bacteria cannot grow. Once the sealing article is broken or removed, the unit should be immediately given to the infant or child for use. If not used within a limited period of time—for example, within four hours from the time the seal is broken—the unit should be disposed of.

The unit is preferably designed in a way which precludes it from being used as a conventional pacifier. The size and weight of the rigid cover or base, and absence of hooks, loops or holes in this cover, assures that an adult must hold the pacifier for the infant while it is in use. An absence of ridges on the nipple-shaped portion can also inhibit an infant from sucking on the nipple without adult support, since the unit will otherwise fall from infant's mouth.

The unit is preferably manufactured in two different sizes to accommodate infants from a 34 week gestation onwards until eighteen months of age. The smaller size, which is intended for preterm infants, contains about 3 mls of sucrose solution while the larger one, intended for full term babies up to eighteen months of age, contains about 5 mls of sucrose solution.

In use, the mother or care giver of the infant can administer an oral analgesic to an infant by a method comprising the steps of:

(a) removing a protective seal from a dispensing device having a container portion that holds a dose of an analgesic liquid and having a contiguous nipple-shaped portion designed to be sucked by the infant; and

(b) allowing the infant to suck on the nipple-shaped portion to pacify the infant while at the same time dispensing and administering the analgesic liquid to the infant through an opening in the nipple-shaped portion, wherein a dose of the analgesic liquid disposed in the container portion and the nipple-shaped portion of the dispensing device, the dose having a having a volume in the range of 1 to 10 ml and the analgesic liquid consisting essentially of a water solution of sucrose and having a sucrose concentration in the range of 20 to 60% w/v; and

(c) disposing of the dispensing device after use. For a full understanding of the present invention, reference should now be made to the following detailed description of the preferred embodiments of the invention as illustrated in the accompanying drawings.

### BRIEF DESCRIPTION OF THE DRAWINGS

FIG. 1 is a cross-sectional, representational diagram of a dispensing device for an analgesic liquid in accordance with a first preferred embodiment of the present invention.

FIG. 2 is a cross-sectional, representational diagram of a dispensing device for an analgesic liquid in accordance with a second preferred embodiment of the present invention.

FIG. 3 is a cross-sectional, representational diagram of a dispensing device for an analgesic liquid in accordance with a third preferred embodiment of the present invention.

FIG. 4 is a representational diagram showing packaging of a dispensing device for an analgesic liquid in accordance with a first preferred embodiment of the present invention.

FIG. 5 is a representational diagram showing packaging of a dispensing device for an analgesic liquid in accordance with a second preferred embodiment of the present invention.

### DESCRIPTION OF THE PREFERRED EMBODIMENTS

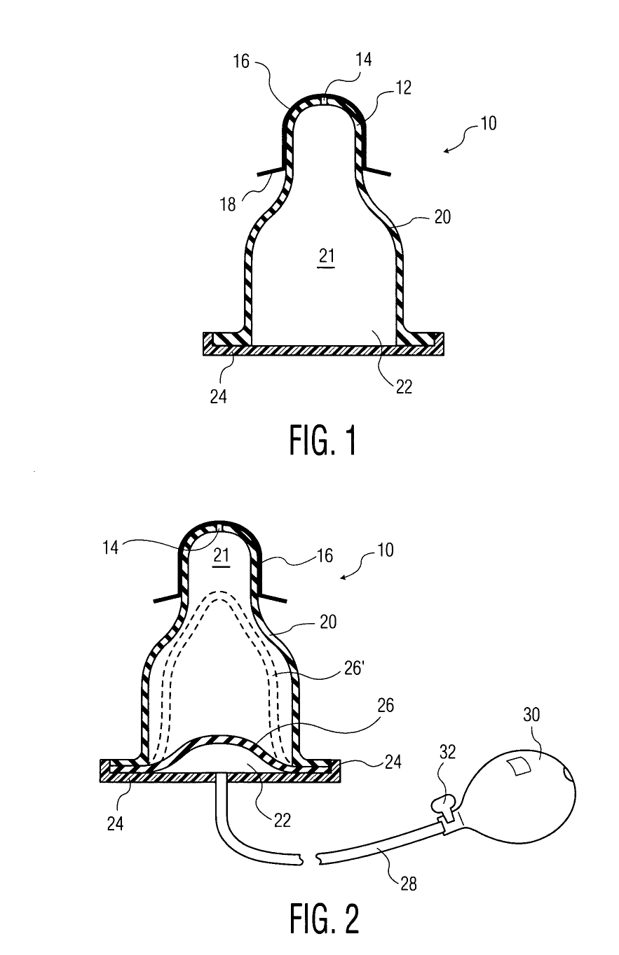

The preferred embodiments of the present invention will now be described with reference to FIGS. 1-5 of the drawings. Identical elements in the various figures are designated with the same reference numerals.

Referring to the FIG. 1, the unit 10 according to the invention comprises a hollow, silicone nipple 12 designed to fit into a neonate, infant or toddler patient's mouth. As is shown in the figure, the nipple is shaped to avert its retention in the patient's mouth unless the unit is held there in position by an adult. The nipple has at least one orifice 14 at its uppermost tip which is sealed with a rigid membrane 16. The membrane 16 has a lip 18 that facilitates its easy removal at the time of usage.

The hollow nipple 12, and the container 20 formed integrally therewith by the descending sides thereof, are filled with 50% w/v sucrose solution 21, which may be with or without a preservative, via an opening 22 opposite the orifice 14. Following filling, the opening 22 is closed with a rigid cover 24 and permanently sealed, for example by crimping the edges. The rigid cover 24 is preferably free of loops, rings and holes to avoid its being held by an infant. The entire unit is then packaged in plastic wrap (not shown) and vacuum sealed.

According to the invention the dose of liquid in the nipple-shaped portion and the container portion of the unit has a volume in the range of 2 to 6 ml. A unit for a young infant preferably has a liquid dose of approximately 3 ml, whereas a unit for an older infant, up to 18 months of age preferably has a dose of approximately 5 ml. The sucrose concentration in the water solution is preferably in the range of 35 to 55% w/v or about 50% w/v.

FIG. 2 shows a second embodiment of the unit 10 wherein a bladder 26 is disposed between the container 20 and the cover 24. The bladder 26 is elastic and can stretch upward into the position shown in dashed lines 26′ when air is forced into the portion of the container beneath it. Such air is introduced through a flexible tube 28 from a squeeze bulb 30 having an air release valve with a knob 32 (similar to that used in connection with a blood pressure cuff). As the lower portion of the bladder 26 is filled with air by squeezing the bulb 30, the sucrose solution 21 above the bladder is forced out through the opening 14 into the infant's mouth.

The sucrose solution 21 contained in the article of manufacture 10 is a solution of table sugar, also called saccharose, in water. Sucrose is a disaccharide of glucose and fructose, with a molecular formula C₁₂ H₂₂ O₁₁. Sucrose is readily digested in the stomach into its component sugars, by acidic hydrolysis. This step is performed by a glycoside hydrolase, which catalizes the hydrolysis of sucrose to the monosaccharides glucose and fructose. Glucose and fructose are rapidly absorbed into the blood stream and, in small amounts, have no deleterious side effects.

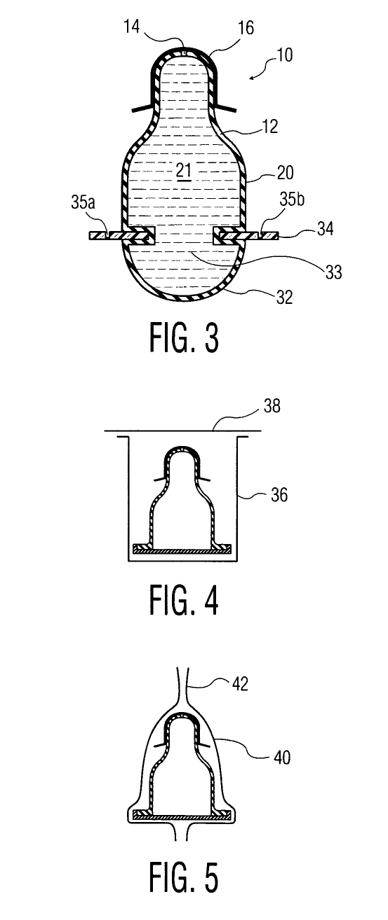

FIG. 3 shows a third embodiment of the unit 10 wherein the container 20 includes a bulb portion 32 that may be squeezed or pressed by an adult to force liquid out through the opening 14 into the infant's mouth. The bulb portion 32 extends outward through an opening 33 in the rigid cover 34.

As is illustrated in FIG. 3, the nipple 12 and container 20 including the bulb 32 are formed as an integral silicone part. After this part is formed, the bulb 32 is pressed through the opening 33 in the cover 34, and the bulb is filled with the analgesic liquid 21 by injecting the liquid through the opening 14.

Holes 35a and 35b, which are at least 0.2 inches wide and are spaced at least 0.2 inches from the outer edges of the rigid cover, serve to prevent possible asphyxiation of the infant while the unit is in use.

FIGS. 4 and 5 illustrate two types of packaging which may be used for storing and transporting the unit according to the invention, while maintaining the unit in a sterile condition. In FIG. 4, the unit 10 is placed in a small cup 36 which is closed and sealed by a tear-able or removable cover 38 that provides a sterile environment for the unit 10.

In FIG. 5, the unit is packaged and sealed within a flexible foil wrapper 40 which may be of plastic, metal foil or the like. Air within the package 40 is evacuated to insure and maintain sterility until the foil seal is broken. The flexible foil 40 is preferably provided with a tear-able portion 42 for easy opening of the sterile package.

There has thus been shown and described a novel device for administering a does of analgesic liquid to an infant which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A disposable article of manufacture adapted for use by an infant to provide an analgesic effect, said article comprising:
(a) a dispensing device having a container portion for holding an analgesic liquid and a contiguous nipple-shaped portion designed to be sucked by an infant, for pacifying the infant while at the same time dispensing and administering the analgesic liquid to the infant through at least one opening in the nipple-shaped portion;
(b) a dose of the analgesic liquid, in sterile form, disposed in at least one of said container portion and said nipple-shaped portion of the dispensing device, said dose having a having a volume in the range of 1 to 10 ml, said analgesic liquid consisting essentially of a water solution of sucrose and having a sucrose concentration in the range of 20 to 60% w/v; and
(c) a removable article for sealing the opening in the nipple-shaped portion and the dose of analgesic liquid, thereby to prevent entry of bacteria into the analgesic liquid and prevent discharge of the analgesic liquid when the dispensing device is not in use.

2. The article defined in claim 1, wherein said nipple-shaped portion has a tip with an opening therein for dispensing the analgesic liquid and wherein said removable article comprises a removable rigid membrane shaped to surround the nipple-shaped portion and to cover said opening.

3. The article defined in claim 1, wherein said container portion of said dispensing device comprises a rigid base portion and a flexible body portion which covers the base portion and extends outward therefrom to said nipple-shaped portion, and wherein said dose of liquid analgesic is disposed in both said container portion and said nipple-shaped portion.

4. The article defined in claim 3, wherein said flexible body portion and said nipple-shaped portion are integrally formed of a flexible material.

5. The article defined in claim 4, wherein said material is silicone.

6. The article defined in claim 1, wherein said container portion is formed of a flexible material allowing a user to squeeze at least some of the dose of analgesic liquid disposed therein into the nipple-shaped portion for dispensing the liquid to the infant.

7. The article defined in claim 1, further comprising a squeeze bulb, coupled to said container portion, for injecting a fluid into the container portion.

8. The article defined in claim 7, wherein said fluid is air.

9. The article defined in claim 7, wherein said fluid is water.

10. The article defined in claim 7, wherein said fluid is said analgesic liquid.

11. The article defined in claim 7, wherein said container includes a bladder to separate the fluid injected therein from the analgesic liquid.

12. The article defined in claim 1, wherein said dose has a volume in the range of 2 to 6 ml.

13. The article defined in claim 12, wherein said dose has a volume of approximately 3 ml.

14. The article defined in claim 12, wherein said dose has a volume of approximately 5 ml.

15. The article defined in claim 1, wherein said analgesic liquid has a sucrose concentration in the range of 35 to 55% w/v.

16. The article defined in claim 1, wherein said analgesic liquid has a sucrose concentration of approximately 40% w/v.

17. The article defined in claim 1, wherein said analgesic liquid has a sucrose concentration of approximately 50% w/v.

18. The article defined in claim 1, wherein said dispensing device is weighted to cause it to fall from an infant's mouth unless it is held in position by a facilitator.

19. The article defined in claim 3, wherein the rigid base portion is weighted such that the dispensing device has a tendency to fall from an infant's mouth unless it is held in position by a facilitator.

20. The article defined in claim 1, wherein the nipple-shaped portion is shaped so as to avert its retention in an infant's mouth unless the dispensing device is held in position by a facilitator.

21. The article defined in claim 1, further comprising a package surrounding the dispensing device containing the dose of analgesic liquid and the removable article sealing the opening.

22. The article defined in claim 21, wherein said package is sterile inside, thereby providing a sterile environment for the dispensing device.

23. The article defined in claim 22, wherein air in said package is evacuated, thereby providing a vacuum package.

24. The article defined in claim 21, wherein said package includes a tear-able portion to permit easy opening.

25. A method of administering an oral analgesic to an infant comprising the steps of:
(a) removing a protective seal from a dispensing device having a container portion that holds a dose of an analgesic liquid and having a contiguous nipple-shaped portion designed to be sucked by the infant; and
(b) allowing the infant to suck on the nipple-shaped portion to pacify the infant while at the same time dispensing and administering the analgesic liquid to the infant through an opening in the nipple-shaped portion, wherein a dose of the analgesic liquid disposed in the container portion and the nipple-shaped portion of the dispensing device, the dose having a having a volume in the range of 1 to 10 ml and the analgesic liquid consisting essentially of a water solution of sucrose and having a sucrose concentration in the range of 20 to 60% w/v; and
(c) disposing of the dispensing device after use.
